(19) United States
(12) Patent Application Publication
(10) Pub. No.: US 2020/0151993 A1
(43) Pub. Date: May 14, 2020

(54) IMPERSONAL BIOMETRIC GAME LOCKING METHODS AND SYSTEMS

(71) Applicant: IGT, Las Vegas, NV (US)

(72) Inventors: Michael Russ, Graz (AT); Sven Aurich, Schwanberg (AT); Stefan Keilwert, St. Josef (AT); Elisabeth Kiss, Unterpremstätten (AT); Bruno Rittner, Hausmannstaetten (AT); Rainer Stimpfl, Gössendorf (AT)

(21) Appl. No.: 16/186,902

(22) Filed: Nov. 12, 2018

(51) Int. Cl. G07F 17/32

(52) U.S. Cl. CPC G07F 17/3206; G07F 17/3241; G07F 17/34; G07F 17/3209; G07F 17/3239

(57) ABSTRACT

A method can be used to unlock gaming devices and/or a functionality of a gaming device based on an impersonal player identification (ID) and obtained biometric information for a player. A player may be scanned by a biometric feature scanning device and an impersonal player ID and gaming account may be generated for the player without requiring the storage of identity information about the player other than the biometric information for the player. Based on a characteristic, gaming history, and/or the presence of the player at a gaming device, access to features of the gaming device are selectively controlled.

### BACKGROUND

The present disclosure is generally directed to biometric locking systems and, in particular, toward locking and unlocking functions of a gaming device in a casino using biometric information. delated

Electronic Gaming Machines (EGMs) and other gaming devices generally require players to deposit money to access games provided by the devices. In some cases, a player may insert cash, coins, or other physical tokens into a particular gaming device and, when a minimum play-cost is met, the gaming device “unlocks” to allow the player to play a game on the gaming device. Other gaming devices may similarly unlock plays by receiving an appropriate amount of money from a credit card, tracking card, fob, or other physical token presented by the player.

### BRIEF SUMMARY

In certain embodiments, the present disclosure relates to a system, device, and method used to unlock gaming devices and/or a functionality of a gaming device based on an impersonal biometric identification of a player. In some embodiments, an impersonal biometric identification and gaming device function locking system is provided, comprising: a biometric feature scanning device; a processor coupled to the biometric feature scanning device; and a memory coupled with and readable by the processor and storing therein instructions that, when executed by the processor, cause the processor to: initiate, via the biometric feature scanning device, a biometric scan of an individual within a scanning zone of the biometric feature scanning device; receive, from the biometric feature scanning device and based on the biometric scan, biometric information for the individual; determine, based on the biometric information, an impersonal characteristic of the individual other than identity information about the individual; determine, based on the impersonal characteristic, whether the individual is authorized to access a function of a gaming device; and control a state of the gaming device providing selective access to the function of the gaming device when the individual is determined to be authorized based at least partially on the impersonal characteristic.

In some embodiments, a method for selectively locking gaming devices using impersonal biometric identification obtained from individuals is provided, the method comprising: scanning, by a biometric feature scanning device, an individual within a scanning zone of the biometric feature scanning device for biometric information; receiving, by a processor, from the biometric feature scanning device, the biometric information for the individual; determining, by the processor and based on the biometric information, an impersonal characteristic of the individual other than identity information about the individual; determining, by the processor and based on the impersonal characteristic, whether the individual is authorized to access a function of the gaming device; and controlling, by the processor, a state of the gaming device providing selective access to the function of the gaming device when the individual is determined to be authorized based at least partially on the impersonal characteristic.

In some embodiments, a gaming device is provided comprising: a biometric scanner; a processor coupled to the biometric scanner; and a memory coupled with and readable by the processor and storing therein instructions that, when executed by the processor, cause the processor to: scan, via the biometric scanner, biometric features of a person within a scanning zone of the biometric scanner; receive, based on the scan, biometric information defining a relationship between the biometric features of the person scanned; determine that the biometric information of the person scanned is stored in a memory device comprising memory locations for a plurality of previously scanned people; retrieve, from a memory location of the memory device and based on the biometric information, a unique impersonal player identification (ID) and gaming information for the person, wherein the memory device is free of identity information for the person other than the biometric information; determine, based on the gaming information retrieved, whether the person is authorized to access a function of the gaming device; and operate the computer gaming device in a locked state preventing access to the function of the computer gaming device when the person is determined to be unauthorized.

Additional features and advantages are described herein and will be apparent from the following Description and the figures.

### BRIEF DESCRIPTION OF THE SEVERAL VIEWS OF THE DRAWINGS

FIG. 1 is a block diagram of a gaming system accordance with embodiments of the present disclosure;

FIG. 2 is a block diagram depicting an illustrative biometric feature scanning device in accordance with embodiments of the present disclosure;

FIG. 3 is a block diagram depicting an illustrative gaming device in accordance with embodiments of the present disclosure;

FIG. 4A is a block diagram depicting a first illustrative data structure used in accordance with embodiments of the present disclosure;

FIG. 4B is a block diagram depicting a second illustrative data structure used in accordance with embodiments of the present disclosure;

FIG. 5 is a flow diagram depicting a method of determining an impersonal player identification based on a biometric scan of an individual in accordance with embodiments of the present disclosure;

FIG. 6 is a flow diagram depicting a method of controlling functions of a gaming device based on impersonal biometric identification information in accordance with embodiments of the present disclosure;

FIG. 7 is a flow diagram depicting a first method of controlling lock functions of a gaming device using impersonal biometric identification information in accordance with embodiments of the present disclosure;

FIG. 8 is a flow diagram depicting a second method of controlling lock functions of a gaming device using impersonal biometric identification information in accordance with embodiments of the present disclosure; and

FIG. 9 is a flow diagram depicting a method of selectively locking functions of a gaming device using impersonal biometric identification information and player presence information in accordance with embodiments of the present disclosure.

### DETAILED DESCRIPTION

Embodiments of the present disclosure will be described in connection with a gaming system having one or multiple gaming devices that enable gaming activity. While certain embodiments of the present disclosure will reference the use of an Electronic Gaming Machine (EGM) as a device that enables players to participate in gaming activity, it should be appreciated that embodiments of the present disclosure are not so limited. For instance, any computing device, personal gaming device, or collection of computing devices may be used to facilitate player engagement with a gaming system.

Embodiments of the present disclosure provide systems and methods that use biometric information (e.g., obtained via fingerprint scan, iris scan, retinal scan, thermal imaging, facial scan, etc.) along with impersonal data (e.g., information that is absent any private information such as an individual's name, address, etc.) for an individual in a casino environment. In some embodiments, players may have their biometric identification, or information, scanned, which allows the players to enable the functionality of gaming devices and/or receive awards without needing to carry player tracking cards, physical tokens, or other physical devices/items with them. The methods and systems described herein provide impersonalized lock functions controlled when an individual is scanned at different gaming devices, stations, and/or places in the casino environment (e.g., confirming the individual's presence based on a biometric identification for the individual, etc.). The lock functions may lock parts of gaming machines, functions provided by gaming machines, or entire gaming machines based, for example, on player intention. In some embodiments, the gaming device may provide player protection actions (e.g., locking or unlocking functions of the gaming device, rendering warnings, etc.) to prevent gaming and/or wagering overconsumption. The overconsumption may be defined by the player or by the casino. Among other things, embodiments of the present disclosure address several technical problems associated with the use of physical tokens in accessing the functionality of a gaming device. For instance, physical tokens may only unlock the ability to play a game on the gaming device. As such, anyone who presents the appropriate amount of cash, coins, or credit to a gaming device (e.g., via a physical token) is allowed to play at the gaming device. Unfortunately, physical tokens can be easily misplaced, lost, or stolen. Once lost or stolen, the physical tokens can be used by anyone to access any remaining gaming credit, retrieve awards, or continue to access gaming devices and plays with the physical tokens.

In some embodiments, a player may create a new impersonal gaming account by scanning their biometrics at a biometric feature scanning device, or scanner. The biometric information from the scan may be tagged with an impersonal player identification (ID), such as an ongoing, or incrementing, number for each new impersonal gaming account, an ID with a timestamp and/or a date stamp, or any other information for assigning an ID that is absent identity information. Biometric identification systems associate biometric information obtained from a person with other identity information such as the person's name, address, social security number, national identification number, and/or some other personal information about the person that can be used to determine an identity of the person. This information may be considered “sensitive” and, in some jurisdictions, must be protected. In contrast to the conventional combined identity information identification systems, embodiments of the present disclosure create an impersonal gaming account for a player based on the player's public, or non-sensitive, biometric information (e.g., facial features, fingerprints, iris features, etc.). The impersonal gaming account may only include information that is relevant to gaming for the player and, in some embodiments, may not include sensitive identity information that could be used to determine an identity of the person. In some embodiments, the impersonal gaming account may be restricted from including, or linking to, any additional identity information other than the biometric information. The only identity information in an impersonal gaming account may be the biometric information obtained from a person that is used to identify an impersonal gaming account associated with, and/or assigned to, the user. In this example, no other information associated with the impersonal gaming account could be used to determine an identity of the person. While this biometric information may identify an impersonal gaming account that is associated with the person, the biometric information alone (e.g., without other additional identity information, etc.) may not determine an identity of the person.

Once an impersonal gaming account is created, data collected over time may be associated with the impersonal player ID that is saved with the impersonal gaming account. In some cases, data collected may be shared with the player (e.g., restoring game progress of the last gaming session for the player, etc.). Some data may be tracked and utilized for any purpose (e.g., record which games the player plays most often or most likely and, thus, may be used to suggest newly released games of a similar kind to the player, etc.).

In some embodiments, the impersonal player ID for a player may be saved on remote servers, on casino-internal servers, or on wider area servers such as within a casino group, a state, area, international region, etc. The impersonal player ID may be stored locally on and optionally transferred from a device (such as a particular biometric feature scanning device or a gaming device comprising a biometric scanning device, etc.) to one or more remote servers using wired or wireless network technologies. The impersonal player ID may be retrieved by the same device or another device being part of the network. Additionally or alternatively, real-time bidirectional communication between the one or more devices with the one or more remote servers may be considered. For example, when a player logs into a first gaming device using the biometric information associated with an impersonal player ID, a “logged-in status” may be sent by the first gaming device to a remote server. Continuing this example, when the player attempts to log into a second gaming device in the same manner, the second gaming device may request data from the remote server and, depending on allowed gaming variations, may inform the player that the impersonal player ID is already in use at the first gaming device.

Once an impersonal gaming account is created, progress made by a player may be saved to the impersonal gaming account associated with the impersonal player ID and/or restored/retrieved at any other gaming device, machine, or terminal in the gaming network that the player logs into. In one embodiment, the device may be a terminal integrated into, or next to, a gaming machine, a stand-alone access terminal, and/or a mobile device (e.g., a smartphone, tablet, etc.) with a biometric scanner (used in the casino environment, from home, or some other location). In some embodiments, one or many of these devices may be integrated into the casino network system.

In any event, the embodiments described herein disclose an entirely new system of gaming device access and functionality based on an impersonal player ID and gaming account determined from biometric information of a player. Embodiments of the present disclosure allow for gaming devices to be unlocked, functions of games played on the gaming devices (e.g., levels of play, preferences, settings, etc.) to be unlocked, gaming devices in special areas of a casino to be unlocked, special offers for players based on gaming history, etc., all while maintaining the players identity information, privacy, and in some cases, anonymity.

The term “impersonal biometric identification” may refer to the use of a biometric identification system (such as a fingerprint scanning device, iris or retinal scanning device, face scanning device, etc.) to accurately determine one person from another in a gaming system without attaching the biometric information to a scanned individual's private, or other personal, information (e.g., such as the individual's name, an address, contact information, or other identity information). Although the biometric information may be considered to qualify as identity information, the biometric information (e.g., fingerprints, facial features, iris features, etc.) of a person is not necessarily hidden from the public. The impersonal biometric identification may be stored without including, or even linking to, additional identity information (e.g., names, social security numbers, national identification numbers, credit card numbers, physical addresses, phone numbers, email addresses, IP addresses, passport number, date of birth, genetic information, birthplace, personally identifiable information (PII), etc.). In some embodiments, the impersonal gaming accounts described herein may be absent any PII, or link to PII, as defined by the General Data Protection Regulation (GDPR), NIST Special Publication 800-122, etc., other than the biometric information obtained from a person. In one embodiment, the only identity information included in the impersonal gaming account may be a player's biometric information stored in a template that defines relationships (e.g., distances, sizes, etc.) between, and of, biometric features of the player. Storing the player's biometric information in a template, among other things, does not allow an identifiable image or a reconstruction of the person to be recreated. Through using impersonal identification, it can be determined whether or not person X, who is scanned at a first gaming device, is the same person X who is scanned at the same or another gaming device. However, it cannot be determined that person X's name is Patrick, that he lives in North America, or that he has a mailing address of XYZ.

Embodiments of the present disclosure focus on impersonal biometric identification and not on personal biometric identification.

At least some benefits of the impersonal identification (e.g., compared to personal identification and/or play tracking cards or other loyalty items) include, but are in no way limited to, not needing to verify contact information when scanning a person's biometrics, providing easy and fast impersonal gaming account creation (e.g., the player is just an impersonal ID and does not have a name, so there is no need for signatures or other confirmations, etc.), the impersonal gaming account may even be created without letting the player know of the impersonal gaming account creation, providing easy and fast impersonal gaming account login (e.g., without the need to carry along any items such as a player card or other gadgets, etc.) the login can even happen without letting the player know. Additionally or alternatively, the player intended to be addressed based on the impersonal player ID is the actual person to be addressed compared with a tracking card or other gadgets that might be lost, stolen, or transferred to other individuals. For instance, if a person is intended to personally read an informative message, requiring a confirmation (click “Confirm”, etc.), it is far more likely that the person intended to read the message is the person who confirmed the message (compared to a loyalty card that a player can give someone else).

The present disclosure describes the use of a system in a casino environment, focusing on impersonalized lock functions, enabled and/or eased by using impersonal biometric identification. There are several use cases describing the lock functions to lock both parts of a gaming machine or whole gaming machines based on player intention, and player protection actions to prevent overconsumption, either defined by the player or the casino.

The biometric feature scanning devices described herein may include, but are in no way limited to, scanners at a casino entrance, on the casino floor or at special spots of interest, integrated into a gaming device (such as an EGM, etc.), from mobile devices, and/or mobile scanners carried by casino staff.

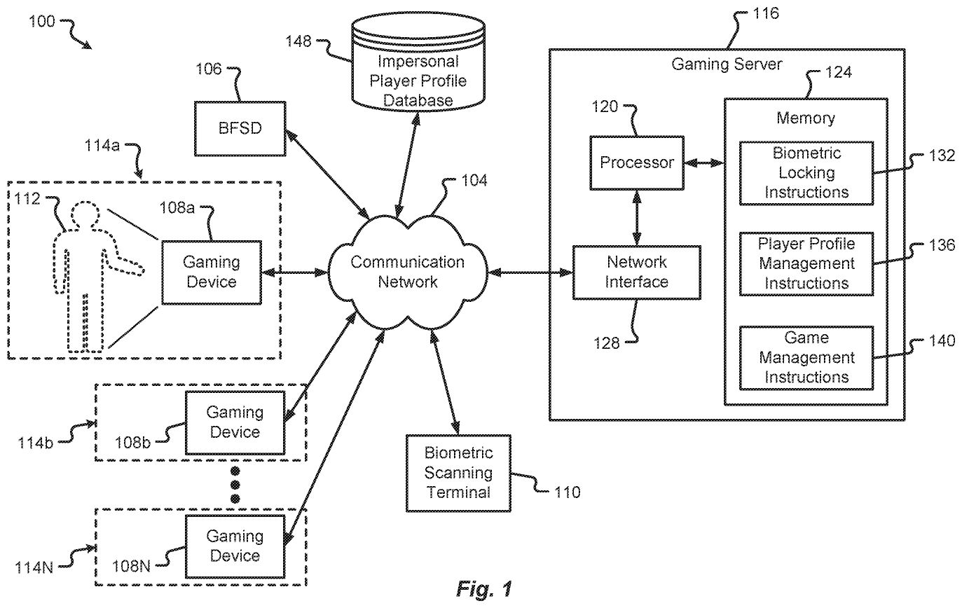

With reference initially to FIG. 1, details of an illustrative gaming system 100 will be described in accordance with at least some embodiments of the present disclosure. The components of the gaming system 100, while depicted as having particular instruction sets and devices, is not necessarily limited to the examples depicted herein. Rather, a system according to embodiments of the present disclosure may include one, some, or all of the components depicted in the system 100 and does not necessarily have to include all of the components in a single device. For instance, the components of a server may be distributed amongst a plurality of servers and/or other devices (e.g., an EGM, portable user device, etc.) in the system 100 without departing from the scope of the present disclosure.

The gaming system 100 is shown to include a communication network 104 that interconnects and facilitates machine-to-machine communications between one or multiple biometric feature scanning devices 106, gaming devices 108a-N, and/or biometric scanning terminal 110, and a gaming server 116. It should be appreciated that the communication network 104 may correspond to one or many communication networks without departing from the scope of the present disclosure. In some embodiments, the biometric feature scanning devices 106, gaming devices 108a-N, and/or biometric scanning terminal 110, and server(s) 116 may be configured to communicate using various nodes or components of the communication network 104. The communication network 104 may comprise any type of known communication medium or collection of communication media and may use any type of protocols to transport messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a cellular network, and any other type of packet-switched or circuit-switched network known in the art. In addition, it can be appreciated that the communication network 104 need not be limited to any one network type, and instead may be comprised of a number of different networks and/or network types. Moreover, the communication network 104 may comprise a number of different communication media such as coaxial cable, copper cable/wire, fiber-optic cable, antennas for transmitting/receiving wireless messages, and combinations thereof

In some embodiments, the biometric feature scanning devices 106, the gaming devices 108a-N, and/or the biometric scanning terminals 110 may be distributed throughout a single property or premises (e.g., a single casino floor) or the biometric feature scanning devices 106, the gaming devices 108a-N, and/or the biometric scanning terminals 110 may be distributed among a plurality of different properties. In a situation where the biometric feature scanning devices 106, gaming devices 108a-N, and/or biometric scanning terminals 110 are distributed in a single property or premises, the communication network 104 may include at least some wired connections between network nodes. As a non-limiting example, the nodes of the communication network 104 may communicate with one another using any type of known or yet-to-be developed communication technology. Examples of such technologies include, without limitation, Ethernet, SCSI, PCIe, RS-232, RS-485, USB, ZigBee, WiFi, CDMA, GSM, HTTP, TCP/IP, UDP, etc.

The biometric feature scanning devices 106, the gaming devices 108a-N, and/or the biometric scanning terminals 110 may utilize the same or different types of communication protocols to connect with the communication network 104. It should also be appreciated that the gaming devices 108a-N may or may not present the same type of game to a player 112. For instance, the first gaming device 108a may correspond to a gaming machine that presents a slot game to the player 112, the second gaming device 108b may correspond to a video poker machine, and other gaming devices may present other types of games or a plurality of different games for selection and eventual play by the player 112. It may be possible for the some of the biometric feature scanning devices 106, gaming devices 108a-N, and/or biometric scanning terminals 110 to communicate with one another via the communication network 104. In some embodiments, one or more of the gaming devices 108a-N may only be configured to communicate with a centralized management server and/or the gaming server 116. Although not depicted, the system 100 may include a separate server or collection of servers that are responsible for managing the operation of the various biometric feature scanning devices 106, gaming devices 108a-N, and/or biometric scanning terminals 110 in the gaming system 100. It should also be appreciated that the gaming server 116 may or may not be co-located with one or more gaming devices 108a-N in the same property or premises. Thus, one or more biometric feature scanning devices 106, gaming devices 108a-N, and/or biometric scanning terminals 110 may communicate with the gaming server 116 over a WAN, such as the Internet. In such an event, a tunneling protocol or Virtual Private Network (VPN) may be established over some of the communication network 104 to ensure that communications between a gaming device (e.g., an EGM, etc.) and a remotely-located server 116 are secured.

The biometric feature scanning devices 106 may correspond to a type of device that scans biometric features of an individual within a scanning zone of the biometric feature scanning devices 106. Biometric features may include an individual's facial features (e.g. the eyes, nose, mouth, ears, chin, etc.), fingerprint features (e.g., loop, whorl, arch, ridge, valley, etc.), temperature signature (e.g., body heat pattern, temperature profile, etc.), eye features (e.g., iris, retinal, or other information), voice features (e.g., speaker recognition, tone, voice biometrics, etc.) and/or other biometric features associated with a human. In some embodiments, the biometric feature scanning device 106 may be configured to detect one or more of the biometric features (e.g., facial, fingerprint, iris/retinal, etc.) associated with a human. Examples of biometric feature scanning devices 106 may include, but are in no way limited to, a facial recognition system, a fingerprint scanner/reader, iris scanning system, voice recognition system, and/or combinations thereof.

In addition to detecting a biometric feature of a player 112, the biometric feature scanning device 106 may record biometric information of the features corresponding to, for example, the type, size, area, relationship, distances, and/or aspect ratio of one or more of the player's 112 biometric features. This information may be saved in a memory location of a database 148 in lieu of an image of the biometric feature itself. Among other things, this approach allows the gaming system 100 to determine an impersonal identification of a player 112 based on the biometric information without using identity information about the player 112 such as photos, videos, or actual print images (e.g., fingerprint, iris, retinal, etc.). It is an aspect of the present disclosure that one or more biometric feature scanning devices 106 may be attached to, or incorporated in, a gaming device 108. In some embodiments, the biometric feature scanning device 106 may operate as stand-alone kiosk, identification system, or preauthorization machine (e.g., the biometric scanning terminal 110 located apart from a gaming device 108) in a gaming system 100.

The gaming devices 108a-N may correspond to a type of device that enables player 112 interaction in connection with playing games of chance. A gaming device 108a-N may include any type of known gaming device such as an EGM, a slot machine, a table game, an electronic table game (e.g., video poker), a skill-based game, a mobile device, etc. In addition to playing games on a gaming device 108a-N, the player 112 may also be allowed to interact with and play games of chance on a mobile device. A mobile device may correspond to a player's 112 personal device or to a device issued to the player 112 during the player's visit at a particular casino. It should be appreciated that the player 112 may play games directly on their mobile device and/or the mobile device may be in communication with a gaming device 108a-N such that the mobile device provides the interface for the player 112 to the gaming device 108a-N. The mobile device may be in communication with the communication network 104 or in direct communication (e.g., via Bluetooth, WiFi, etc.) with a gaming device 108a-N. Non-limiting examples of a mobile device include a cellular phone, a smart phone, a tablet, a wearable device, an augmented reality headset, a virtual reality headset, a laptop, a Personal Computer (PC), or the like.

The biometric scanning terminals 110 may comprise a biometric feature scanning device 106 as part of a stand-alone terminal. In some embodiments, a biometric scanning terminal 110 may comprise one or multiple components of the biometric feature scanning device 106 and one or multiple components of the gaming device 108. It is an aspect of the present disclosure that the biometric scanning terminal 110 may serve as a preauthorization terminal where players may register, or preregister, to play specific machines, certain games, or access a gaming area 114 in the gaming system 100. In one embodiment, the biometric scanning terminal 110 may be used by a player prior to entering a gaming area 114 (e.g., of a casino) to authenticate the player in the gaming system 100. For instance, the biometric scanning terminal 110 may be located outside of a gaming area 114 where one or more gaming devices 108a-N are located. In some embodiments, players may be restricted from entering a gaming area 114 having a gaming device 108 without being authorized via the biometric scanning terminal 110. This restriction may include controlling automatic locks, doors, gates, and/or the like via signals sent from the biometric scanning terminal 110.

The gaming server 116 is further shown to include a processor 120, memory 124, and a network interface 128. These resources may enable functionality of the gaming server 116 as will be described herein. For instance, the network interface 128 provides the server 116 with the ability to send and receive communication packets or the like over the communication network 104. The network interface 128 may be provided as a network interface card (NIC), a network port, drivers for the same, and the like. Communications between the components of the server 116 and other devices connected to the communication network 104 may all flow through the network interface 128.

The processor 120 may correspond to one or many computer processing devices. For instance, the processor 120 may be provided as silicon, as a Field Programmable Gate Array (FPGA), an Application-Specific Integrated Circuit (ASIC), any other type of Integrated Circuit (IC) chip, a collection of IC chips, a microcontroller, a collection of microcontrollers, or the like. As a more specific example, the processor 120 may be provided as a microprocessor, Central Processing Unit (CPU), or plurality of microprocessors that are configured to execute the instructions sets stored in memory 124. Upon executing the instruction sets stored in memory 124, the processor 120 enables various authentication functions of the gaming server 116.

The memory 124 may include any type of computer memory device or collection of computer memory devices. The memory 124 may be volatile and/or non-volatile in nature. The memory 124 may include one or many different types of memory devices without departing from the scope of the present disclosure. Non-limiting examples of memory 124 include Random Access Memory (RAM), Read Only Memory (ROM), flash memory, Electronically-Erasable Programmable ROM (EEPROM), Dynamic RAM (DRAM), etc. The memory 124 may be configured to store the instruction sets depicted in addition to temporarily storing data for the processor 120 to execute various types of routines or functions. Although not depicted, the memory 124 may include instructions that enable the processor 120 to store data into an impersonal player profile database 148 and/or ticket/voucher database 152 and retrieve information from the databases 148, 152. Alternatively or additionally, the impersonal player profile database 148 or data stored therein may be stored internal to the server 116 (e.g., within the memory 124 of the server 116 rather than in a separate database). Alternatively or additionally, the ticket/voucher database 152 or data stored therein may be stored internal to the server 116.

The illustrative instruction sets that may be stored in memory 124 include, without limitation, a biometric locking instructions 132, a player profile management instruction set 136, and a game management instruction set 140. Functions of the server 116 enabled by these various instruction sets will be described in further detail herein. It should be appreciated that the instruction sets depicted in FIG. 1 may be combined (partially or completely) with other instruction sets or may be further separated into additional and different instruction sets, depending upon configuration preferences for the server 116. Said another way, the particular instruction sets depicted in FIG. 1 should not be construed as limiting embodiments described herein.

In some embodiments, the biometric locking instructions 132, when executed by the processor 120, may enable the gaming server 116 to manage various locking signals provided to the gaming devices 108a-N, manage lock states associated with the gaming devices 108a-N, determine game messages, determine gaming devices 108a-N associated with particular player access areas 114a-N, update the impersonal player profile database 148, obtain information from the gaming devices 108a-N, determine that a function of a gaming device 108 is accessible and notify the player profile management instruction set 136 and/or game management instructions 140, etc. In some embodiments, the biometric locking instructions 132 is configured to perform any action consistent with the locking/unlocking of gaming devices 108a-N, locking/unlocking features of the gaming devices 108a-N, altering recorded states of the gaming devices 108a-N, and the like.

The player profile management instruction set 136, when executed by the processor 120, may enable the gaming server 116 to manage one or more player profiles within the impersonal player profile database 148. In some embodiments, the player profile management instruction set 136 may be configured to manage gaming credits, gaming history, offers enrolled in and/or received by a player 112, devices used or unlocked by the player 112, and store impersonal biometric information for a player 112. In some embodiments, the player profile management instructions 136 may be configured to manage settings for each player profile, available wager credits for such profiles, determine player wager history, and/or determine which, if any, tickets/vouchers are associated with a particular impersonal player ID. It should also be appreciated that the player profile management instruction set 136 may be configured to manage player profiles of players that do not have loyalty accounts or any other predetermined player account.

The game management instruction set 140, when executed by the processor 120, may enable the gaming server 116 to manage the various games played by a player 112 at the gaming devices 108a-N and/or a mobile device carried by the player 112. In other words, any game played by the player 112 at one or more of the devices 108a-N may be managed, partially or entirely, by execution of the game management instruction set 140. The game management instructions 140 may unlock features, levels, bonuses, etc., associated with a gaming device 108, based on the information from the biometric locking instructions 132, and the impersonal player ID of a player 112. The game management instruction set 140 may also be configured to track a status of wager events (e.g., sporting events, bingo, keno, lottery, etc.) and whether a player 112 has placed a wager on such events. In some embodiments, when a wager event has come to completion such that wagers made on the event become payable (e.g., at the end of a sporting event when the final score of the event is determined), the game management instruction set 140 may notify a ticket/voucher management instruction set stored in the memory 124, thereby enabling the ticket/voucher management instruction set to update states and/or values of tickets/vouchers issued for the event appropriately.

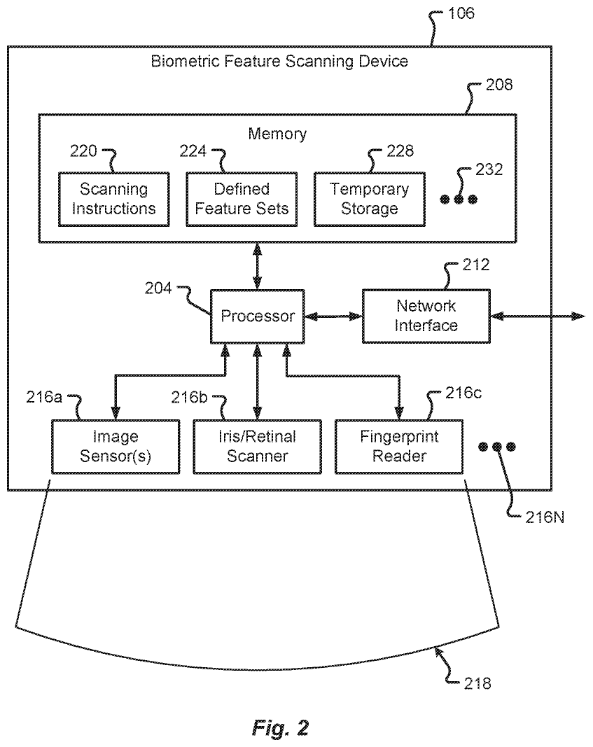

FIG. 2 is a block diagram depicting an illustrative biometric feature scanning device 106 in accordance with at least some embodiments of the present disclosure. The biometric feature scanning device 106 may include a processor 204, a memory 208, a network interface 212, and one or multiple scanning devices 216. In some embodiments, the processor 204 may be similar or identical to the processor 120. For example, the processor 204 may correspond to one or many microprocessors, CPUs, microcontrollers, or the like. The processor 204 may be configured to execute one or more instruction sets or rules 232 stored in memory 208.

The network interface 212 may also be similar or identical to network interface 128. The nature of the network interface 212, however, may depend upon whether the network interface 212 is provided in a stand-alone biometric feature scanning device 106, in a gaming device 108, a biometric scanning terminal 110, a mobile user device, or some other machine that interfaces with one or more devices in the gaming system 100. Examples of a suitable network interface 212 include, without limitation, an Ethernet port, a USB port, an RS-232 port, an RS-485 port, a NIC, an antenna, a driver circuit, a modulator/demodulator, etc. The network interface 212 may include one or multiple different network interfaces depending upon whether the biometric feature scanning device 106 is connecting to a single communication network 104 or multiple different types of communication networks 104. For instance, the biometric feature scanning device 106 may be provided with both a wired network interface and a wireless network interface without departing from the scope of the present disclosure.

The scanning devices 216 may include any device configured to detect a biometric feature of an individual within a scanning zone 218. The scanning zone 218 may correspond to a reading or detection distance from the scanning devices 216. Although the biometric feature scanning device 106 may only require one scanning device 216 to obtain biometric information about an individual in order to generate an impersonal gaming account and player ID, embodiments of the present disclosure anticipate that the biometric feature scanning device 106 can include multiple scanning devices 216. The scanning devices 216 may include, but are in no way limited to, one or more image sensors 216a, iris/retinal scanners 216b, fingerprint reader 216c, and/or other scanning devices 216N.

The image sensors 216a may include one or more cameras that are capable of obtaining image data of subject individual. In one embodiment, the image sensors 216a may obtain two-dimensional or three-dimensional data for an individual within the scanning zone 218. Two-dimensional data may be detected by at least one image sensor 216a and used by the processor 204 to map a number of biometric features, sizes of biometric features, and/or distances between biometric features for an individual, in two dimensions (e.g., along an X-axis and along a Y-axis, orthogonal to the X-axis, etc.). In addition to the two-dimensional data, three-dimensional data may be detected by at least two image sensors 216a and used by the processor 204 to determine a depth or range distance of various biometric features, or parts of biometric features, for the individual (e.g., along a Z-axis that extends along an axis that is perpendicular to a plane defined by the X-axis and the Y-axis, such as the XY-plane). In any event, the data obtained from the one or many image sensors 216a may be stored as numbers in a biometric feature template. The template may comprise dedicated memory locations for specific biometric information (e.g., measurements of and/or between recognized biometric features, etc.). This template may be stored with an impersonal player ID in the impersonal player profile database 148. The biometric information in the template may characterize an identity of a player 112, without storing identity information about the player 112. This identity may be used to differentiate between players 112 in the gaming system 100.

The iris/retinal scanner 216b may comprise an image sensor, light, and/or laser configured to measure features of a person's eye. In one embodiment, the iris/retinal scanner 216b may obtain pattern information from blood vessels on the retina of the eye. In some embodiments, the iris/retinal scanner 216b may obtain images of the iris of a person's eye via at least one infrared or other image sensor. The images may define pattern information about features of the iris including, but in no way limited to, color, shape, location, of portions of the iris. Similar to the data obtained by the image sensors 216a, the data obtained from the iris/retinal scanner 216b may be stored as numbers in a biometric feature template. The template may comprise dedicated memory locations for specific biometric information (e.g., measurements of and/or between recognized biometric features, etc.). This template may be similarly stored and associated with an impersonal player ID to differentiate between players in the gaming system 100.

The fingerprint reader 216c may comprise an optical scanner system or a capacitive scanning sensor that are configured to detect and measure distances between features of a human finger or hand print. The fingerprint reader 216c may determine a number of biometric features associated with a print, such as a number, size, and location of valleys, ridges, bifurcations, minutiae, and/or other features. This biometric information may be used to characterize a pattern for a print that may uniquely identify an individual. Similar to the data obtained by the image sensors 216a and the iris/retinal scanner 216b, the data obtained from the fingerprint reader 216c may be stored as numbers in a biometric feature template. The template may comprise discrete memory locations for specific biometric information in the pattern (e.g., measurements of and/or between recognized biometric features, etc.). This template may be similarly stored and associated with an impersonal player ID to differentiate between players 112 in the gaming system 100.

Activities of the biometric feature scanning device 106 related to obtaining biometric information from an individual in a scanning zone 218 of the scanning devices 216 may be managed and reported by the scanning instruction set 220. In one embodiment, when a player 112 is present within a scanning zone 218 of one or more scanning devices 216, the scanning instructions 220 may initiate a scan of the player 112 for biometric information. Other scanning triggers may include continually scanning, periodic scanning, time-based scanning, or condition-based scanning. Condition-based scanning may initiate a scan of an individual upon enrolling in an offer, accepting an award, and/or cashing-out or redeeming a ticket/voucher. In any event, the biometric information may be obtained by the scanning instruction set 220 and reported to the gaming server 116. It is an aspect of the present disclosure that the scanning instruction set 220 may update records stored in the impersonal player profile database 148, the ticket/voucher database 152, and/or other memory devices in the gaming system 100.

The memory 208 may be similar or identical to memory 124. For instance, the memory 208 may include one or multiple computer memory devices that are volatile or non-volatile. The memory 208 may be configured to store instruction sets that enable scanning of individuals within the scanning zone of the biometric feature scanning device 106, feature definition templates, temporary storage data, or other rules 232. Once example of an instruction set that may be stored in the memory 208 may include a scanning instruction set 220. Additionally or alternatively, the memory 208 may include a number of defined feature sets 224 for particular biometric features that are scanned by the scanning devices 216. These defined feature sets 224 may include groups of features, patterns, shapes, and relationships between biometric features for facial recognition via image sensors 216a, eye scanning via an iris/retinal scanner 216b, and fingerprint reading via a fingerprint reader 216c. The feature sets may include recognition patterns, established shapes, nomenclature, or memory storage locations in a template to follow when obtaining biometric information from an individual.

A temporary storage location 228 in the memory 208 may be used to temporarily store image information or a data set associated with the biometric features of a person while the processor 204, in conjunction with the scanning instructions 220, determines biometric information representing measurements and/or other characteristics of the biometric features. This temporary storage location 228 may be deleted and/or overwritten when the biometric information is obtained from the image information or data set to ensure no identity information is saved in the gaming system 100. In some embodiments, the biometric information obtained from a person may be stored in one or more memory locations in the memory 208 of the biometric feature scanning device 106.

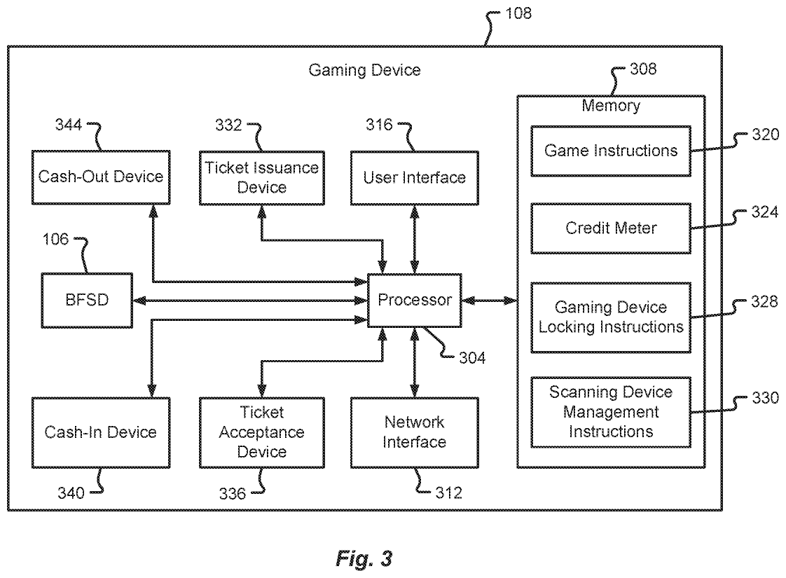

With reference now to FIG. 3, additional details of a gaming device 108 will be described in accordance with at least some embodiments of the present disclosure. While depicted as a gaming device 108, it should be appreciated that some or all of the components of the gaming device 108 may be included in a player's 112 mobile device without departing from the scope of the present disclosure.

The gaming device 108 is depicted to include a biometric feature scanning device 106, a processor 304, memory 308, a network interface 312, a user interface 316, a ticket issuance device 332, a ticket acceptance device 336, a cash-in device 340, and a cash-out device 344. In some embodiments, the processor 304 may be similar or identical to the processor 120. In other words, the processor 304 may correspond to one or many microprocessors, CPUs, microcontrollers, or the like. The processor 304 may be configured to execute one or more instruction sets stored in memory 308.

The network interface 312 may also be similar or identical to network interface 128. The nature of the network interface 312, however, may depend upon whether the network interface 312 is provided in a gaming device 108 or a mobile user device. Examples of a suitable network interface 312 include, without limitation, an Ethernet port, a USB port, an RS-232 port, an RS-485 port, a NIC, a Slot Machine Interface Board (SMIB), components of a SMIB, an antenna, a driver circuit, a modulator/demodulator, etc. The network interface 312 may include one or multiple different network interfaces depending upon whether the gaming device 108 is connecting to a single communication network 104 or multiple different types of communication networks 104. For instance, the gaming device 108 may be provided with both a wired network interface and a wireless network interface without departing from the scope of the present disclosure.

In some embodiments, a stand-alone biometric feature scanning device 106 may communicate with the gaming device 108 via the network interface 312. However, the gaming device 108 may also include a biometric feature scanning device 106 that is configured to scan a player 112 within the scanning zone 218 as described in conjunction with FIG. 2. The integrated biometric feature scanning device 106 may include a processor 204 and memory 208 or utilize at least one of the processor 304 and the scanning device management instructions 330 stored in the memory 308 of the gaming device 108.

The user interface 316 may correspond to any type of input and/or output device that enables the player 112 to interact with the gaming device 108. As can be appreciated, the nature of the user interface 316 may depend upon the nature of the gaming device 108. For instance, if the gaming device 108 is a traditional mechanical reel slot machine, then the user interface 316 may include one or more mechanical reels with symbols provided thereon, one or more lights or LED displays, one or more depressible buttons, a lever or “one armed bandit handle”, a speaker, or combinations thereof. If the gaming device 108 is a digital device, then the user interface 316 may include one or more touch-sensitive displays, LED/LCD display screens, etc.

The memory 308 may be similar or identical to memory 124. For instance, the memory 308 may include one or multiple computer memory devices that are volatile or non-volatile. The memory 308 may be configured to store instruction sets that enable player 112 interaction with the gaming device 108, that enable game play at the gaming device 108, and/or that enable coordination with the gaming server 116. Examples of instruction sets that may be stored in the memory 308 include a game instruction set 320, a credit meter 324, a gaming device locking instructions 328, and a scanning device management instruction set 330.

In some embodiments, the game instructions 320, when executed by the processor 304, may enable the gaming device 108 to facilitate one or more games of chance or skill and produce interactions between the player 112 and the game of chance or skill. In some embodiments, the game instructions 320 may include subroutines that present one or more graphics to the player 112 via the user interface 316, subroutines that calculate whether a particular wager has resulted in a win or loss during the game of chance or skill, subroutines for determining payouts for the player 112 in the event of a win, subroutines for exchanging communications with a connected server (e.g., game management server, gaming server 116, or the like), subroutines for enabling the player 112 to engage in a game using their mobile user device, and any other subroutine or set of instructions that facilitate gameplay at or in association with the gaming device 108. The game instructions 320 may selectively allow access to one or more levels associated with a game on the gaming device 108 based, for example, on a gaming history, experience points, locking instructions, etc. for a player 112.

The credit meter 324 may correspond to a secure instruction set and/or data structure within the gaming device 108 that facilitates a tracking of activity at the gaming device 108. In some embodiments, the credit meter 324 may be used to store or log information related to various player 112 activities and events that occur at the gaming device 108. The types of information that may be maintained in the credit meter 324 include, without limitation, player information, available credit information, wager amount information, and other types of information that may or may not need to be recorded for purposes of accounting for wagers placed at the gaming device 108 and payouts made for a player 112 during a game of chance or skill played at the gaming device 108. In some embodiments, the credit meter 324 may be configured to track coin in activity, coin out activity, coin drop activity, jackpot paid activity, bonus paid activity, credits applied activity, external bonus payout activity, ticket/voucher in activity, ticket/voucher out activity, timing of events that occur at the gaming device 108, and the like. In some embodiments, certain portions of the credit meter 324 may be updated in response to outcomes of a game of chance or skill played at the gaming device 108. In some embodiments, the credit meter 324 may be updated depending upon whether the gaming device 108 is issuing a ticket/voucher, being used as a point of redemption for a ticket/voucher, and/or any other activity associated with a ticket/voucher. Some or all of the data within the credit meter 324 may be reported to the gaming server 116, for example, if such data applies to a centrally-managed game and/or a status of a ticket/voucher. As an example, the number, value, and timing of wagers placed by a particular player 112 and payouts on such wagers may be reported to the gaming server 116.

Activities of the gaming device 108 related to locking/unlocking activity may be managed and reported by the gaming device locking instructions 328. In some embodiments, the gaming device locking instructions 328 may determine a feature control command signal for the gaming device 108 that selectively allows or denies access to the gaming device 108 or a function of the gaming device 108 (e.g., game level, display presentation, bonuses, etc.). In some embodiments, the gaming device locking instructions 328 may work with the scanning device management instruction set 330 to determine an impersonal player ID associated with a player 112. In one embodiment, prior to unlocking a feature or function of the gaming device 108, the gaming device locking instructions 328 may determine the impersonal player ID of a player 112 at the gaming device 108 by initiating a scan of the player 112 via the biometric feature scanning device 106. If no impersonal player ID exists for the player 112, the scanning device management instruction set 330 may report the biometric information for the player 112 to the gaming server 116. In some embodiments, the gaming server 116 may generate the impersonal player ID, which can be stored in a memory of the gaming server 116, a memory of the gaming device 108, and/or in the impersonal player profile database 148. Additionally or alternatively, the gaming device 108 may generate the impersonal player ID, which can be stored in a memory of the gaming device 108, a memory of the gaming server 116, and/or in the impersonal player profile database 148. Upon determining the impersonal player ID for the player 112 (e.g., via scanning the player 112 and searching for the corresponding impersonal player ID and biometric information), the gaming device locking instructions 328 may determine to unlock the gaming device 108, or a feature of the gaming device 108 (e.g., gaming functions, levels, bonuses, etc.) based on information stored in the impersonal player ID. In some embodiments, the gaming device locking instructions 328 may be similar, if not identical, to the biometric locking instructions 132 described in conjunction with FIG. 1.

Activities of the integrated biometric feature scanning device 106, for instance, related to obtaining biometric information of an individual within a scanning zone 218 of the biometric feature scanning device 106 may be managed and reported by the scanning device management instruction set 330. In one embodiment, the scanning device management instruction set 330 may be similar, if not identical, to the scanning instructions 220 described in conjunction with FIG. 2.

Because the gaming device 108 may be used for the acceptance and issuance of tickets/vouchers, the gaming device 108 may be provided with appropriate hardware to facilitate such acceptance and issuance. Specifically, the gaming device 108 may be provided with a ticket acceptance device 336 that is configured to accept or scan physically-printed tickets/vouchers and extract appropriate information therefrom. In some embodiments, the ticket acceptance device 336 may include one or more machine vision devices (e.g., a camera, IR scanner, optical scanner, barcode scanner, etc.), a physical ticket acceptor, a shredder, etc. The ticket acceptance device 336 may be configured to accept physical tickets and/or electronic tickets without departing from the scope of the present disclosure. An electronic ticket/voucher may be accepted by scanning a one-dimensional barcode, two dimensional barcode, or other type of barcode or quick response (QR) code displayed by a player's 112 mobile device, for example. In one embodiment, an impersonal player ID may be present on the electronic ticket/voucher as part of the barcode, QR code, or other visible information on the electronic ticket/voucher.

The ticket issuance device 332 may be configured to print or provide physical tickets/vouchers to players 112. In some embodiments, the ticket issuance device 332 may be configured to issue a ticket/voucher consistent with an amount of credit available to a player 112, possibly as indicated within the credit meter 324. Additionally or alternatively, the impersonal player ID may be printed on the ticket/voucher similar to the presentation on the electronic ticket/voucher.

The cash-in device 340 may include a bill acceptor, a coin acceptor, a chip acceptor or reader, or the like. In some embodiments, the cash-in device may also include credit card reader hardware and/or software. The cash-out device 344, like the ticket issuance device 322, may operate and issue cash, coins, physical tokens, or chips based on an amount indicated within the credit meter 324. In some embodiments, the cash-out device 344 may include a coin tray or the like and counting hardware configured to count and distribute an appropriate amount of coins or physical tokens based on a player's 112 winnings or available credit within the credit meter 324.

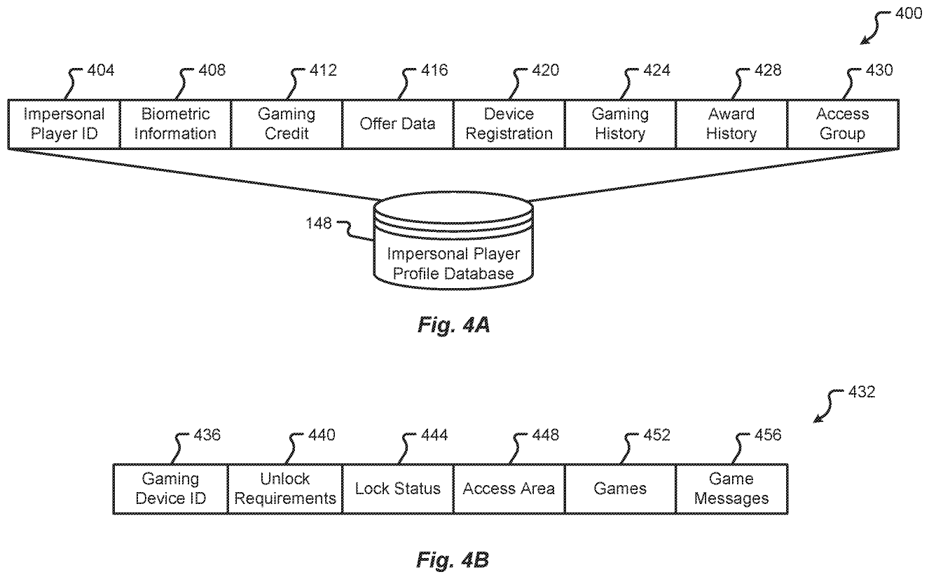

With reference now to FIGS. 4A and 4B, additional details of data structures that are useable in connection with managing impersonal player profiles and gaming device function access will be described in accordance with at least some embodiments of the present disclosure. It should be appreciated that the data structures depicted and described herein may be stored within a central database or may be distributed among a number of data storage nodes. Additionally or alternatively, some or all of the fields of the data structures may be maintained in devices of the gaming system 100 such as the gaming server 116, a biometric feature scanning device 106, a gaming device 108, a biometric scanning terminal 110, and/or a mobile device without departing from the scope of the present disclosure.

With reference initially to FIG. 4A, details of a data structure 400 that may be maintained as part of an impersonal player profile will be described in accordance with at least some embodiments of the present disclosure. Although shown as stored in the impersonal player profile database 148, it should be appreciated that the impersonal player profile data structure 400 can be stored in a memory of the gaming device 108, a memory of the biometric scanning terminal 110, a memory of the gaming server 116, and/or in the impersonal player profile database 148. The database 148 may be configured to store one or multiple data structures 400 that are used in connection with tracking player 112 progress and gaming history. As a non-limiting example, the data structure 400 may be used to store player loyalty information, player history information, and the like. Even more specifically, the data structure 400 may include a plurality of data fields that include, for instance, an impersonal player ID field 404, a biometric information field 408, a gaming credit field 412, an offer data field 416, a device registration field 420, a gaming history field 424, an award history field 428, and an access group field 430.

The impersonal player ID field 404 may be used to store any type of information that impersonally identifies a player 112. In some embodiments, the impersonal player ID field 404 may store an identification character (e.g., number, letter, and/or symbol) and/or a string of characters that uniquely identify one player 112 from another in the database 148, without using identity information. Identity information may include a person's name, nickname, address, contact information, credit card information, social security number, national identification number, mobile device name, internet access IP address, PII, and/or any other information that could be used to discover an identity of the person. In some embodiments, the impersonal player ID field 404 may be a number assigned to a memory location of a data structure 400 in the impersonal player profile database 148. In some embodiments, the data stored in the impersonal player ID field 404 may be randomly generated, pseudo-randomly generated, or sequentially generated based on when an impersonal gaming account for a player 112 is created (e.g., after a first scan of the player 112 for biometric information, etc.). Each player 112 can have a unique memory location, and impersonal player ID in the database 148, for storing information about the player 112 other than identity information. In some embodiments, the impersonal player ID stored in the impersonal player ID field 404 may be automatically assigned to the player 112, for example, without input from the player 112.

The biometric information field 408 may be used to store information about certain biometric features of a player 112. Rather than include an image of the player 112 (e.g., photograph, video, etc.), or an image of a part of the player 112 (e.g., fingerprint, iris, retina, etc.), the biometric information field 408 may include information about a type, size, relationship, pattern, aspect, and/or ratio of a player's biometric features. For instance, a player's 112 facial biometric information may be stored as a set of numbers defining the measurement of a height of the eyes, a width of the eyes, a distance between the eyes, a distance from an eye to the nose, an area defined between the eyes and the nose, etc. The set of numbers may be stored in a template where each measurement is stored in order. As can be appreciated, this information may be used to identify one player 112 from another in the database 148 but cannot be used to personally identify the player 112 outside of the database 148 (e.g., by linking the set of numbers to a name, address, contact information, or other identity information).

In some embodiments, the biometric information field 408 may be used to store information about a determined age range, intent, or behavioral characteristic for a player 112. Determining an age range for a player 112 may include evaluating biometric features for a player 112, based on the biometric information obtained from a player 112, against one or many comparison data sets that define facial features indicative of age. Additionally or alternatively, the biometric information field 408 may store information about an intent of a player 112. Intent may include a determined action for a player 112 based on historical information, past recorded behavior, and the like. In some embodiments, the intent may be based on a position of a player's 112 head, gaze, distance from the gaming device 108, and/or combinations thereof. In some embodiments, the biometric information field 408 may be used to store a behavioral characteristic (e.g., level of intoxication, anxiety, sickness, etc.) for a player 112 that is based on biometric information obtained from the player 112. By way of example, a wandering gaze of a player 112 during a gaming session, heavy eyelids (e.g., eyelids that continually shut for longer than average periods of time, etc.), slurred speech, and/or combinations thereof may be recorded based on the biometric information obtained from a player 112. In any event, the information in the biometric information field 408 may be used to control a locked or unlocked state of a gaming device 108 in the gaming system 100.

The gaming credit field 412 may be used to store data about a player's 112 available credit with a device, with a sports book, with a casino, and/or with a plurality of casinos. For instance, the gaming credit field 412 may store an electronic record of available credit in the player's 112 impersonal gaming account and whether any restrictions are associated with such credit. The gaming credit field 412 may further store information describing a player's 112 available credit over time, wagers placed by the player 112,

The offer data field 416 may be used to store data about offers the player 112 has participated in, is currently enrolled in, and the like. The offer data field 416 may be used to alter a gaming behavior of a gaming device 108 the player 112 is interacting with at any given time. Additionally or alternatively, the offer data field 416 may be used to alter a gaming credit stored in the gaming credit field 412 of the impersonal player profile database 148. In some embodiments, the offer data may depend on a gaming history or past awards of a player 112 (e.g., stored in the gaming history field 424 and the award history field 428, respectively).

The device registration field 420 may be used to store data about the various gaming devices 108a-N used, locked, and/or unlocked by the player 112 over time. In some embodiments, each gaming device 108 may include a device identifier (e.g., a hardware identification, MAC address, IP address, or other unique serial number) that uniquely identifies one gaming device 108 from another in the gaming system 100. Among other things, the device registration field 420 may record preferred gaming devices 108, frequently used gaming devices 108, and/or associate a particular gaming device 108 with issued ticket/vouchers, winning events, cash-out events, and the like. In some cases, the device registration field 420 may be used to establish a playing behavior or preferences for the player 112 having the impersonal player ID. It is an aspect of the present disclosure that the device registration field 420 may be used to store data about past and current lock states of a gaming device 108 (e.g., whether a specific gaming device 108 has been locked, is currently unlocked, and/or whether certain features are unlocked or locked for the gaming device 108).

The gaming history field 424 may be used to store historical data for events that occur with respect to the player 112 while gaming. For instance, the gaming history field 424 may store information related to a player's 112 outcome in a game of chance, a player's 112 outcome in a game of skill, a celebration event for a person other than the player 112, a player's 112 involvement in a celebration event, a player 112 visiting a predetermined location, a player 112 playing a particular game, a player interacting with their mobile device, wagers placed by the player 112, tickets/vouchers issued for the player 112, tickets/vouchers redeemed by the player 112, etc. In some embodiments, the gaming history field 424 may be used to store data related to a progress of a player in a game, a level reached in a game, experience points in a game, features unlocked in the game, and the like.

The award history field 428 may be used to store information associated with cash-out events for the player, winning events for the player, tickets/vouchers issued to the player, offer win percentages, overall awards won, and the like.

The access group field 430 may be used to store information associated with a level of access for a player 112. The level of access may define which gaming devices 108 or games a player 112 can play in a gaming system 100, what bonuses may be offered to the player 112, whether the player is part of a preferred player group (e.g., VIP group), and even what areas 114 of the gaming system 100 a player 112 may access.

With reference now to FIG. 4B, details of another data structure 432 that may be used within the gaming system 100 will be described in accordance with at least some embodiments of the present disclosure. In some embodiments, the second data structure 432 may be stored in the impersonal player profile database 148 or a memory associated with the gaming device 108, the biometric scanning terminal 110, and/or the gaming server 116. In any event, the various memory devices described herein may be configured to store one or multiple data structures 432 that are used in connection with tracking a gaming device 108 lock status, unlock requirements, identification, and the like. In some embodiments, the data stored in the data structure 432 may be stored for a plurality of different gaming devices 108 in the gaming system 100 and may or may not be organized based on game type, gaming area 114, access group, etc. As a non-limiting example, the data structure 432 may be used to store locking information for specific gaming devices 108. Even more specifically, the data structure 432 may include a plurality of data fields that include, for instance, a gaming device ID field 436, an unlock requirements field 440, a lock status field 444, an access area field 448, a games field 452, and a game messages field 456. It should be appreciated that the data structure 432 may have greater or fewer fields than depicted in FIG. 4B.

The gaming device ID field 436 may be used to store a device identifier, such as a hardware identification, MAC address, IP address, or other unique serial number, that uniquely identifies one gaming device 108 from another in the gaming system 100. In some embodiments, the data stored in the gaming device ID field 436 may be associated with one or more devices 108 that a player 112 registers with, locks, or unlocks. For instance, the device ID stored in the gaming device ID field 436 be also be stored in the device registration field 420 to identify devices that a player 112 has interacted with in some capacity.

The unlock requirements field 440 may be used to criteria that a player 112 must meet to unlock a particular gaming device 108. It is an aspect of the present disclosure that different gaming devices 108 may include different unlocking requirements. For example, a first gaming machine may restrict players under a certain age from playing or interacting with the machine. In this example, the unlock requirements field 440 may include an age requirement for the player 112. When a player approaches the first gaming machine, or gaming device 108, the biometric feature scanning device 106 may determine an age range for the player 112 as provided above. Based on the determined age range for the player 112, the gaming device 108 may refer to the unlock requirements field 440 to determine the acceptable age of players required before the gaming device 108 can be unlocked. If the determined age range of the player 112 is scanned is lower than the certain age stored in the unlock requirements field 440, the gaming device 108 would maintain a locked status of the gaming device 108. Other unlock requirements may include a behavioral characteristic (e.g., a state of intoxication, etc.) for a player 112, a gaming history for a player 112 (e.g., a level, experience, or progress stored in the gaming history field 424 of the first data structure 400), an access group for the player 112 (e.g., stored in the access group field 430 of the first data structure 400), and/or combinations thereof.

The lock status field 444 may be used to store data indicating a current lock state of a gaming device 108. The lock status (e.g., whether the gaming device 108 is locked or unlocked) may be used by the gaming server 116 in determining available gaming devices 108, grouping gaming devices 108 by area, or automatically locking unlocked devices 108 determined to have been abandoned, or left, by a player 112.

The access area field 448 may be used to store data indicating a particular gaming area 114 associated with a gaming device 108. The gaming areas 114 in a gaming system 100 may be segregated by game type, bonuses offered, age of the devices, whether the gaming device is available to particular players, and the like. In some embodiments, only players who are part of a specific access group (e.g., stored in access group field 430 of first data structure 400) may be able to play a gaming device 108 in a specific access, or gaming, area 114.

The games field 452 may be used to store data about games that are offered, or available, on the gaming device 108 associated with the gaming device ID in the second data structure 432. Games may include, but are in no way limited to, poker, blackjack, Texas Hold'em, slots, bingo, keno, etc.). In some embodiments, the games field 452 may include a type of game associated with the gaming device 108. Examples of types of games hosted or played on the gaming device 108 may include, but are in no way limited to, card games, games of chance, dice games, interactive games, gambling games, skill games, sports betting machines, combinations thereof, etc.

The game messages field 456 may be used to store messages that can be visually rendered and/or audibly output via one or more components of the gaming device 108. The game messages may include warnings, communications, commands, and the like. In some embodiments, game messages may be associated with regulations requiring warnings to be issued when certain types of games are played, when a certain amount of time has been spent playing a game (e.g., overconsumption), when a specific betting limit has been reached, etc. The game messages may be based on jurisdiction, location, or geographical location of the gaming system 100, gaming device 108, gaming area 114, etc. In some embodiments, the game messages may be based on a determined age of the players who are detected playing a game on the gaming device 108. In any event, the game messages for one or more of these scenarios may be stored in the game messages field 456 of the second data structure 432.

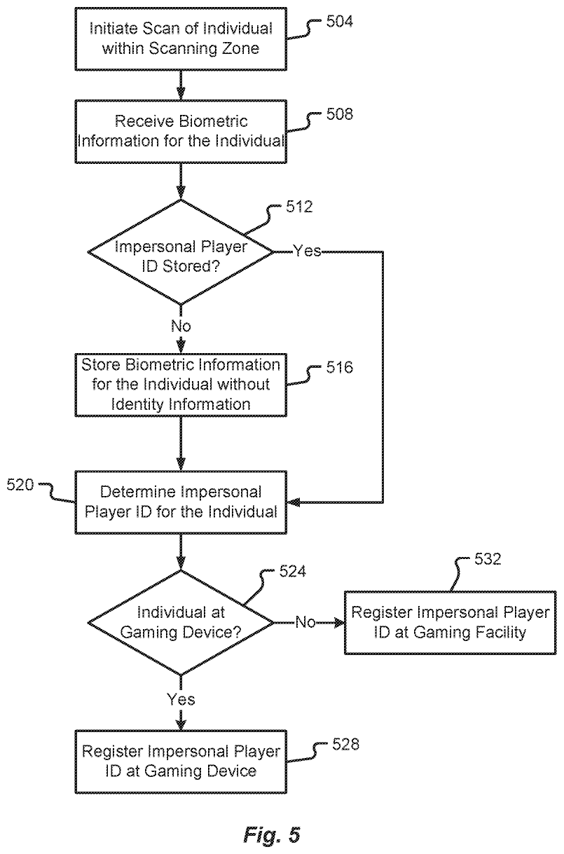

With reference now to FIG. 5, a method of determining an impersonal player ID based on a biometric scan of an individual will be described in accordance with at least some embodiments of the present disclosure. The method begins when a scan for biometric information associated with an individual is initiated (step 504). In some embodiments, the scan may be automatically initiated when the individual enters the scanning zone 218 of a biometric feature scanning device 106 in a gaming system 100. This may include an individual sitting or standing in front of one or many image sensors 216a, positioning their eyes in front of an iris/retinal scanner 216b, and/or placing a finger onto a fingerprint reader 216c. In one embodiment, the scan may be initiated in response to a registration, or login, attempt by a player 112 at a gaming device 108. As described herein, the scanning of individuals within the scanning zone 218 may be performed with or without explicit consent from the individuals or even knowledge of the scanning.

The scan of the individual may be performed by the biometric feature scanning device 106 to determine patterns, sizes, ratios, and the like, between biometric features of the individual. This information may be converted by the biometric feature scanning device 106 into numerical data defining the biometric information for the individual, for instance, without use of any identity information as described in conjunction with FIGS. 1-4B.

The method continues upon receiving the biometric information from the biometric feature scanning device 106 (step 508). In some embodiments, the biometric information may be arranged in a biometric information template as described herein. The biometric information template may comprise discrete memory locations for specific measurement information associated with biometric features.

The method continues by determining whether an impersonal player ID for the scanned individual is associated with the biometric information and stored as part of an impersonal player profile data structure 400, which may or may not be stored in the impersonal player profile database 148 of the gaming system 100 (step 512). In some embodiments, this step may include the biometric feature scanning device 106 or the gaming device 108 reporting the biometric information to the gaming server 116. In response, the gaming server 116 may access the impersonal player profile database 148 and compare the biometric information for the scanned individual against records in the biometric information field 408 of the first data structure 400 for registered players. When a match exists, the gaming server 116 reports the impersonal player ID for the biometric information to the device 106, 108. When there is no match, the method may proceed to generate an impersonal player ID and create a record in the impersonal player profile database 148 for the scanned individual (step 516).

In step 516, the gaming server 116 stores the biometric information for the scanned individual in a biometric information field 408 associated with an unused impersonal player ID. This impersonal player ID is maintained in the impersonal player ID field 404 of the impersonal player profile database 148, and any impersonal records, such as gaming credit, offer data, devices used, gaming history, award history, and the like associated with the scanned individual is stored in the memory location identified by the impersonal player ID.

In some embodiments, the impersonal player ID and the first data structure 400 represents an impersonal gaming account for a player 112. This impersonal gaming account may be completely absent of any identity information for the player 112 (e.g., other than the biometric information obtained from the player 112). For instance, the impersonal gaming account may include playing history, settings, information, and identifiers that could not otherwise be used to identify the player 112. In fact, the biometric information stored in the biometric information field 408 only includes numerical measurement, pattern, and/or template data. As can be appreciated, this information could not be used to recreate identity information of a player 112 and may only be used to describe a player 112 in general terms outside of the gaming system 100. In some embodiments, the impersonal gaming account may not even include a link to identity information or other memory locations having identity information for the player 112.

The method continues by determining the impersonal player ID for the player 112 (step 520). This determination may include receiving the impersonal player ID from the gaming server 116 or directly accessing the impersonal player profile database 148 and retrieving the impersonal player ID therefrom.

As previously described, a player 112 may be scanned by a stand-alone biometric feature scanning device 106 or by a biometric feature scanning device 106 integrated into a gaming device 108. The player 112 may be registered with a device (e.g., gaming device 108) or a facility (e.g., casino, etc.) based on the device that scanned the player 112. The method may continue by determining whether the player 112 is at a gaming device 108 (step 524). If so, the gaming device 108 may register the player's 112 impersonal player ID at the gaming device 108 (step 528). In some embodiments, this registration may include reporting the presence of the player 112 at the gaming device 108 to the gaming server 116. In one embodiment, the gaming device 108 or the gaming server 116 may update a device registration record stored in the device registration field 420 of the first data structure 400 for the player 112.

On the other hand, if the player 112 is not at a gaming device 108, the player 112 may be determined to be at a facility registration kiosk, stand-alone biometric feature scanning device 106, or other registration machine. In response, the method may register the player at the gaming facility (step 532). In one embodiment, the facility registration may include reporting the presence of the player 112 at a registration device to the gaming server 116. In some jurisdictions a player 112 may be required to pre-register before being allowed to enter a casino. This pre-registration may be made at the stand-alone biometric feature scanning device 106 and in accordance with step 532 of the method.

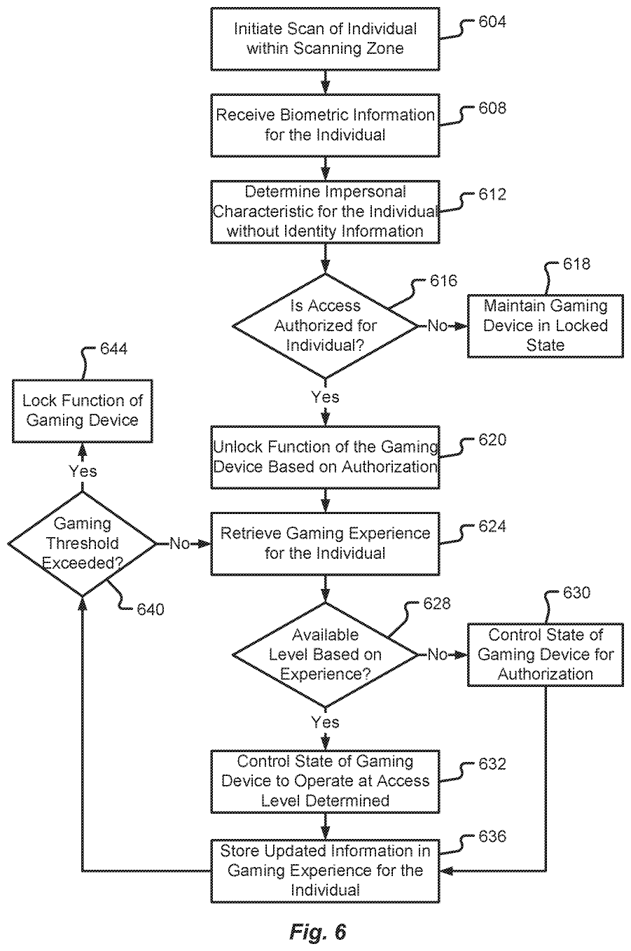

Referring now to FIG. 6, a flow diagram depicting a method of controlling functions of a gaming device based on impersonal biometric identification information is described in accordance with at least some embodiments of the present disclosure. The method begins when a scan for biometric information associated with an individual is initiated (step 604) and continues when the biometric information is received from the biometric feature scanning device 106 (step 608). In some embodiments, steps 604 and 608 of FIG. 6 may be similar, if not identical, to steps 504 and 508 described in conjunction with the method and flow diagram of FIG. 5.

Based on the biometric information received, the method continues by determining an impersonal characteristic for the individual (step 612). The impersonal characteristic may correspond to data stored in an impersonal player profile or another characteristic of the individual, other than identity information, that is used by the gaming device 108 and/or the gaming server 116 to determine if a player 112 is allowed to unlock a particular gaming device 108. Characteristics may include, but are in no way limited to biometric information (e.g., a determined age range for the individual, a state of intoxication for the individual, identification of the individual,), device registration for the player, gaming history/experience for the player, an access group associated with the player 112 and the like.

The method may continue by determining whether the individual scanned at step 604 is authorized to access a function of the gaming device 108 (step 616). The function of the gaming device 108 may include unlocking the device 108, unlocking a game on the device 108, and/or unlocking a level associated with a game on the device. Other unlock functions can include turning on a display of the device 108, allowing interactions between a player and the device 108, allowing wagers to be placed by the device 108, and/or allowing access to one or more credits for a player 112 via the device 108. In some embodiments, the authorization process may include the biometric locking instruction set 132 or the gaming device locking instruction set 328, when executed by the processor 120, 304, comparing the characteristics for the individual to one or more unlock requirements for the gaming device 108 (e.g., stored in the unlock requirements field 440).

If the individual scanned is not identified or if the individual fails to meet the unlock requirements for the gaming device 108, the individual is not authorized to access the gaming device 108 and the method continues by maintaining the gaming device 108 in a locked state (step 618). Stated another way, if the individual is not authorized, the gaming device 108 cannot be unlocked by the individual.

However, if the individual scanned is identified as an authorized player (e.g., having an impersonal player ID stored in memory), the method may continue by determining to unlock a function of the gaming device 108 based on the authorization (step 620). The unlock function may comprise providing access to a game on the gaming device 108 or providing access to an interaction screen to a display for the authorized player to select a particular game to play.

In some embodiments, the method may proceed by retrieving gaming experience for the authorized player (step 624). This information may be retrieved from the impersonal gaming account associated with the impersonal player ID for the authorized player. In one embodiment, the impersonal gaming account may correspond to the impersonal player profile stored in the first data structure 400, for example, in the impersonal player profile database 148. As provided above, the gaming experience may be stored in a gaming history field 424 of the first data structure 400. The gaming experience may define a highest level in a game played by the authorized player, a last level played, a game progress for the player, and/or other playing and achievement history.

The method continues by determining whether a particular gaming access level is available for the authorized player based on the gaming experience retrieved (step 628). The access level may refer to presentations, preferences, settings, levels, offers, and/or other information that is related to or depends on the gaming experience of the authorized player. By way of example, if the authorized player reached level 12 of a particular game on the gaming device 108 in the past, the access level may allow the authorized player to continue from level 12, receive a perquisite or offer based on the level reached, be included in a special players group, import preferences and settings, or receive a different presentation to be rendered via the gaming device display (step 632). If no access level is available, the method proceeds to step 630, by controlling the state of the gaming device based on the authorization information.

As the authorized player interacts with the gaming device 108, plays games, and/or changes settings and preferences, the method continues by storing updated information for the authorized player in the impersonal player profile associated with the impersonal player ID (step 636). In some embodiments, updating the information may include storing new information at least in the gaming history field 424 of the first data structure 400, for instance, in the impersonal player profile database 148.

Embodiments of the present disclosure allow for monitoring and locking of a gaming device 108 or a functionality of a gaming device 108 based on overconsumption, times of use, bets made, and limits on the same. In one embodiment, the method continues by determining, based on the gaming experience information for the authorized player, whether the authorized player has exceeded a predetermined gaming threshold (step 640). The predetermined gaming threshold may be stored in a data structure associated with the player 112 (e.g., impersonal player profile database 148), with the gaming device 108 (e.g., data structure 432), and/or with the gaming server 116 (e.g., data structures 400, 432). The predetermined gaming threshold may be based on regulated gaming limits, preferences set by a casino, preferences set by an individual, etc.

In the event that a player exceeds limits, the method may proceed by locking a function of the gaming device 108 (step 644). This function lock may or may not be accompanied by a gaming message that is rendered to a display of the gaming device 108 informing the player of the limit. In some embodiments, the gaming message may be rendered before locking a function of the gaming device 108. For instance, a user may be approaching a gaming threshold, at which point, the message may be rendered via the gaming device 108 to warn the player of the limit. The message may be stored in the game messages field 456 of the second data structure 432 or any other data structure 400 described herein.

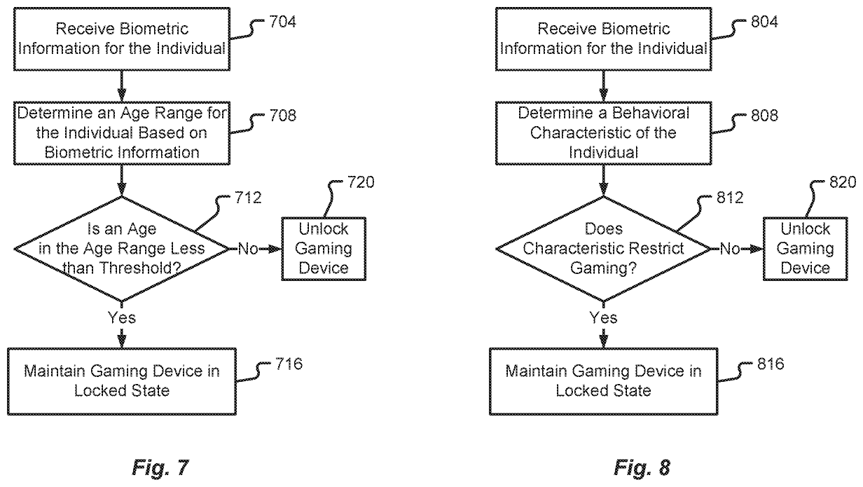

FIGS. 7 and 8 are flow diagrams of various methods of controlling lock functions of a gaming device 108 using impersonal biometric identification information in accordance with embodiments of the present disclosure. In FIGS. 7 and 8, the gaming device 108 may be locked, for example, as a default state while on a casino floor. The methods may each begin by receiving biometric information for an individual (steps 704, 804). In some embodiments, steps 704, 804 may correspond to step 508 described in conjunction with the method of FIG. 5.

In FIG. 7, the method determines an age range for an individual based on the biometric information received (step 708). The determined age range is compared to a predetermined age threshold stored in memory to determine whether an individual is allowed to operate a gaming device (step 712). In some cases, the predetermined age threshold may be an age defined for an adult in a particular jurisdiction (e.g., 18 years old, 21 years old, etc.). If the determined age range does not include an age that is less than the predetermined threshold, the method continues by unlocking the gaming device (step 720). However, in the event that the determined age range for the individual includes an age that is less than the threshold, the method continues by maintaining the locked state of the gaming device 108 (step 716). In some embodiments, this process may be performed before an individual touches a gaming device 108. By way of example, a gaming device 108 may be on a gaming floor of a casino displaying a minimum amount of information via a display. If an underage individual attempts to interact with the gaming device 108, the method may optionally display a message that the individual is underage, render a cartoon, or turn off the screen such that no information is displayed to the underage individual. Conversely, when an of-age individual interacts with the gaming device 108, the method may optionally proceed by presenting a full amount of information, increased options, increase a brightness, play sounds, or otherwise change the information presented via the gaming device 108.

In FIG. 8, the method determines a behavioral characteristic of an individual based on the biometric information received (step 808). The behavioral characteristic may be compared to a predetermined restrictive characteristic stored in memory to determine whether the individual is allowed to operate the gaming device 108 (step 812). The characteristic may correspond to a state of mind (e.g., intoxicated, tired, ill, etc.) or a gaming behavior (e.g., attempted cheating, etc.) determined for the individual. If the determined characteristic does not restrict gaming (e.g., focused playing, smiling, attentive eye gaze, etc.), the method continues by unlocking the gaming device (step 820). However, in the event that the determined characteristic does restrict gaming (e.g., attempted cheating, intoxicated, wandering gaze, etc.), the method continues by maintaining the locked state of the gaming device 108 (step 816). Similar to the method described in conjunction with FIG. 7, this method may be performed before an individual touches a gaming device 108. Accordingly, the presentations of the gaming device 108 may be limited or enhanced, based on whether an individual is restricted or not, respectively, as described above.

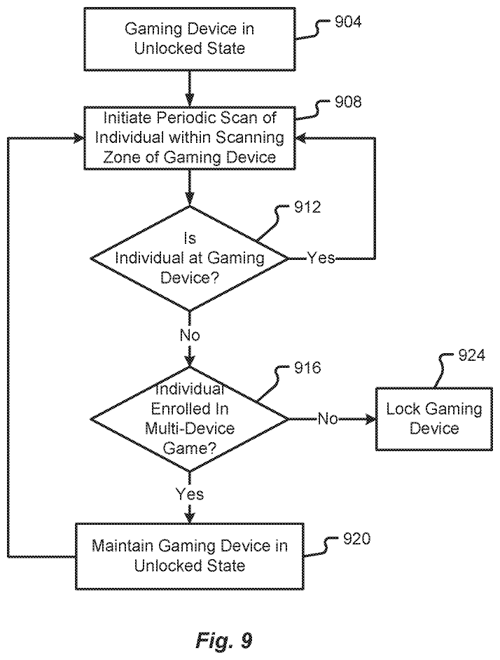

Referring now to FIG. 9, a flow diagram depicting a method of selectively locking functions of a gaming device 108 using impersonal biometric identification information and player presence information is shown in accordance with embodiments of the present disclosure. The method begins when a gaming device is operated in an unlocked state (step 904).

The method continues by initiating a periodic scan for the player at the gaming device 108 (step 908). In one embodiment, the biometric information for the individual may be received in response to initiating a rescan of the individual within the scanning zone 218 of the biometric feature scanning device 106 for the gaming device 108. This rescan may be similar to the scan described in conjunction with step 504 of FIG. 5. For example, the rescan may continually obtain biometric information for an individual at the gaming device 108. As provided above, the rescan may be performed by the biometric feature scanning device 106 of the gaming device 108 on a continual or periodic basis. In some cases, the rescan may be performed in response to a condition associated with the game at the gaming device 108. By way of example, as a player 112 accumulates credit or achievements, the gaming device 108 may determine to rescan the player 112 to ensure the biometric information for the scanned player 112 matches the biometric information for the impersonal player ID registered at the gaming device 108. As another example, the gaming device 108 may determine to rescan the player 112 when the player attempts to cash-out or transfer credits from one gaming device 108 to another in the gaming system 100. These rescans serve as a security check and fraud prevention system that serves to reward or allow access only to the appropriate player 112.

The method continues by determining, based on the rescan, whether the player 112 who previously unlocked the gaming device 108 is still present) at the gaming device 108 (step 912). If so, the method returns to step 908. However, if the gaming server 116 or the gaming device 108 determines that the biometric information obtained from the rescan fails to match the biometric information for the player 112 who previously unlocked the gaming device 108 (e.g., via the biometric information stored with the player's 112 impersonal player ID), the method proceeds to determine whether the player 112 is enrolled in a multi-device game (e.g., possibly requiring the player to sit between one or more gaming devices 108, or be absent from one gaming device 108, while playing) (step 916). In some embodiments, a player 112 may, at times, be able to use two or more gaming devices 108 in a gaming system 100. As can be appreciated, the player 112 may not be detected by one gaming device 108 while sitting or standing at an adjacent or nearby gaming device 108. Multiple device gaming may be allowed based on the type of games offered at the gaming devices 108, information in the impersonal player profile database 148 for the player 112, facility offerings, and/or combinations thereof. If the player is not enrolled in a multiple device game, the method proceeds by locking the gaming device 108 (step 924). In some embodiments, locking the gaming device 108 may also include updating the record stored in the device registration field 420 of the impersonal player profile for the player 112. This locking of devices 108 when a player has left the device 108 and does not intend to return thereto serves as a security feature, preventing gaming information associated with another player from being observed. Additionally or alternatively, locking devices 108 when players are not present serves to allow the machines to be unlocked by other players who may wish to interact with the devices 108.

However, in the event that the player is enrolled in a multiple device game, the method continues by maintaining the gaming device 108 in the unlocked state (step 920). While the gaming device 108 may be maintained in an unlocked state for the player during a multi-device game, it should be appreciated that no other player can access the unlocked gaming devices 108 during this time. Stated another way, the gaming devices 108 would appear locked to anyone who does not match the biometric information for the player who unlocked the gaming devices 108 for the multi-device game.

In addition to the embodiments described above, the present disclosure offers a number of additional benefits and features.

In some embodiments, a player may be able to lock an EGM for a time period while not present at the EGM (e.g., for a bathroom break, etc.) and upon returning to the EGM, the player's biometrics may be rescanned to unlock the EGM. In one embodiment, the maximum amount of time that a player could lock an EGM may be set by the casino or the player. While the player is absent, the game could be frozen, or the player may select to allow the game to continue to play in an auto-play mode. In this example, the player may be able to define how long the auto-play mode should continue playing automatically (e.g., spins to play, play until player decision required, play until credit meter limit reached, etc.). In some embodiments, upon returning, the player may be able to review the session in a “fast motion” format to determine what was won/lost while the player was absent.

In one embodiment, players may reserve an EGM at home using the biometric feature scanner of their mobile devices. Based on the specific impersonal player ID, the player could schedule a casino visit for a particular time (e.g., 5:00 PM) and reserve the EGM until another time (e.g., 5:10 PM).

The gaming device 108 may be configured to only show intimate game information (e.g., credit meter, bet, bonus, or loyalty points collected, etc.) when the player is at the gaming device 108. The player may scan their biometrics to lock/hide the information and then rescan to unlock/show the information. In some embodiments, the gaming device 108 may display account statistics, sensitive cash statistics of current and previous casino visits, (e.g., including self-set limits per casino visit, per month etc.) when scanned at any EGM.

The impersonal player ID may be used to activate/enable/confirm critical player decisions, such as, activating a high-roller mode, confirming that rules are understood when entering skill features, confirming when credits >limit “x” are set to play for (e.g., player defined “max bet to play with: 500c” and when approaching a game and the bet >500c is selected, player must confirm selection), confirming safety instructions (e.g., motion sickness at virtual reality (VR) games, that the player understands the danger of Ultrahaptics, beams, or when using any other technology that could harm the player if used incorrectly, etc.).

In some embodiments, the gaming device 108 may scan player when a jackpot is being paid out and confirm that impersonal player ID is not blacklisted (e.g., due to cheating, suspected cheating, etc.).

In one embodiment, the player may confirm or accept player consumption warnings (e.g., every X games a safety message might appear, such as “gambling is dangerous” etc., which may be required by law). To confirm that the message was read, the player may scan their biometrics via the biometric feature scanning device 106 of the gaming device 108.

In some embodiments, the gaming device 108, or EGM, may perform a player eligibility scan to play a game. For instance, prior to a casino visit, biometrics might be scanned to check if player associated with a known impersonal player ID is allowed to enter the casino. Additionally or alternatively, all EGMs on the casino floor may be locked and players can only unlock and play them via a biometric scan. In the event that the player is eligible to play, the EGM is unlocked and can be played.

In some embodiments, when entering a casino, a player's 112 biometrics may be scanned, and the player might set their personal limit to play for (e.g., maximum money spent, maximum games played, maximum time played, etc.). Once the limit is reached, the player may be informed and might be locked from playing. In one embodiment, a player and/or casino staff may be able to extend the limit.

As provided above, access groups may be defined in a casino environment. Only specific player groups (e.g., based on gaming experience or loyalty status), might be eligible to play at different areas in the casino. Prior to each gaming session, a player's biometrics may be scanned and experience/progress in loyalty status made may be saved to the impersonal gaming account or record associated with the impersonal player ID. The player may be notified or informed once promoted to next player group. In some embodiments, a “beginner's area” may be different from an “advanced player area” and/or a “VIP player area.” In one embodiment, each area might have different games, offers, snack pricings, etc.

Multiple players may share a single partner impersonal gaming account, associated with multiple impersonal player IDs. Progress and all functions may be available for all associated impersonal player IDs (e.g., if player 1 of the partner impersonal gaming account locks an EGM, player 2 of the same partner impersonal gaming account might be able to unlock the EGM via biometrics).

In some embodiments, the biometric scanners may be combined with emotional state scanners. Via a biometric scan, the gaming device 108 may detect if a player is influenced by drug or alcohol consumption and deny access if limit is reached. Additionally or alternatively, the gaming device 108 may determine a player's age and deny play/access if the player is too young to gamble.

In some embodiments, a player may be allowed to skip instructions (tutorials, game instructions, game rules, safety instructions) when biometrics scanned, and the impersonal player ID is recognized as an “experienced” user. New players and players without biometric scan information (e.g., no impersonal player ID) must watch whole instructions, which could become increasingly important for confirming the rules of skill-games.

In one embodiment, a player sits down in front of an EGM, inserts money and is identified. Once identified, prior to every reel-spin a player identification may be required prior to starting the reels to prevent fraud and to ensure that only the identified player and no one else is playing (security, fraud, responsible gaming). Player identification can be done via a continuous retinal scan, a fingerprint sensor integrated into the play-button, a camera based facial recognition etc.

Player biometric information may be tied to any game, connectivity and security related decisions/confirmation. Instead of a confirmation via pressing and “ok” button, a player's biometric signature may be required to initiate an action.

In some embodiments, multiple EGMs and/or mobile devices may be assigned to a player's impersonal player ID and the multiple devices may be played simultaneously (locking devices from being played by other players), at the same time prevent other player's from taking over an assigned and actively played machine.

Based on gambling experience, the functionalities in games may be locked until player has gained the required experience to advance and unlock the functionalities. At every step player's biometric information may be scanned automatically. Once an achievement is collected, it can be associated with the player's impersonal player ID. For example, a player may start with a tutorial, then play 5 free spins (without win) to show how the game behaves, play X games with lowest bet to unlock higher bets, play Y luck-based features to be eligible playing skill-based features, and play Z games to become eligible for the big jackpot, etc.

For gaming machines without a biometric scanner, a mobile device comprising a biometric scanner might be used instead. The player may be prompted to scan their biometrics using the mobile device, and once the mobile device is paired with an EGM (e.g., using Wi-Fi, Bluetooth™, IR, NFC, etc.), the impersonal player ID may be transferred to an EGM and the EGM is unlocked using the impersonal player ID.

When entering a casino, visitors may be able to pay for a gaming flat rate or a gaming package (e.g., luck package, skill package, ultimate flat rate, flat rate for Egyptian games, etc.). Based on the package paid for the player can enter the casino, scan their biometrics at an EGM to unlock all functionalities within the package and play.

In some embodiments, when a casino calls out for a casino tournament, players might register using the biometric scanner of the EGM they are currently playing at. Thus, the player can finish their gaming session at the current EGM and register for the tournament without the need to leave the EGM for the reservation. In one embodiment, the EGM at the tournament may be locked until the biometric information of the player is scanned. In one embodiment, mobile devices (either in the casino network, remotely, or from home) may be used to register for the tournament.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

What is claimed is:

1. An impersonal biometric identification and gaming device function locking system, comprising:
a biometric feature scanning device;
a processor coupled to the biometric feature scanning device; and
a memory coupled with and readable by the processor and storing therein instructions that, when executed by the processor, cause the processor to:
initiate, via the biometric feature scanning device, a biometric scan of an individual within a scanning zone of the biometric feature scanning device;
receive, from the biometric feature scanning device and based on the biometric scan, biometric information for the individual;
determine, based on the biometric information, an impersonal characteristic of the individual other than identity information about the individual;
determine, based on the impersonal characteristic, whether the individual is authorized to access a function of a gaming device; and
control a state of the gaming device providing selective access to the function of the gaming device when the individual is determined to be authorized based at least partially on the impersonal characteristic.

2. The system of claim 1, wherein prior to controlling the state of the gaming device, the instructions further cause the processor to:
access a memory device associated with the gaming device;
determine whether an impersonal player identification (ID) exists in a memory location on the memory device, wherein the impersonal player ID identifies the individual without the identity information other than the biometric information for the individual; and
retrieve, from the memory location on the memory device when the impersonal player ID exists in the memory location on the memory device, gaming experience information for the individual associated with the impersonal player ID.

3. The system of claim 2, wherein the instructions that cause the processor to control the state of the gaming device further comprise instructions that cause the processor to:
determine, based on the gaming experience information, an access level for the function of the gaming device; and
control the state of the gaming device to operate at the determined access level for the function of the gaming device.

4. The system of claim 3, wherein the instructions further cause the processor to:
store updated information in the gaming experience information stored in the memory location on the memory device for the impersonal player ID as a gaming history for the individual changes over time.

5. The system of claim 4, wherein the gaming device is connected to a plurality of gaming devices in a gaming facility via a gaming communication network, and wherein each gaming device in the plurality of gaming devices is in a locked state until an individual is scanned and authorized.

6. The system of claim 5, wherein the instructions further cause the processor to:
obtain, periodically by the biometric feature scanning device, subsequent biometric information for individuals within the scanning zone of the biometric feature scanning device; and
determine, based on the processor comparing the subsequent biometric information obtained to stored biometric information for the individual associated with the impersonal player ID, whether the individual is present at the gaming device.

7. The system of claim 6, wherein the instructions further cause the processor to:
lock the function of the gaming device when the biometric feature scanning device fails to detect the individual as present at the gaming device; and
unlock the function of the gaming device when the biometric feature scanning device detects the individual as present at the gaming device.

8. The system of claim 4, wherein the instructions further cause the processor to:
determine, based on the gaming experience information, that the individual has exceeded a gaming threshold stored in the memory location for the impersonal player ID; and
render, by a screen of the gaming device, a message informing the individual that the gaming threshold has been exceeded.

9. A method for selectively locking gaming devices using impersonal biometric identification obtained from individuals, the method comprising:
scanning, by a biometric feature scanning device, an individual within a scanning zone of the biometric feature scanning device for biometric information;
receiving, by a processor, from the biometric feature scanning device, the biometric information for the individual;
determining, by the processor and based on the biometric information, an impersonal characteristic of the individual other than identity information about the individual;
determining, by the processor and based on the impersonal characteristic, whether the individual is authorized to access a function of a gaming device; and
controlling, by the processor, a state of the gaming device providing selective access to the function of the gaming device when the individual is determined to be authorized based at least partially on the impersonal characteristic.

10. The method of claim 9, further comprising:
determining, by the processor and based on the biometric information, an age range of the individual;
locking, by the processor, the gaming device when an age in the age range of the individual is determined to be less than a predetermined threshold age; and
unlocking, by the processor, the gaming device when the age in the age range of the individual is determined to be at or above the predetermined threshold age.

11. The method of claim 9, further comprising:
determining, by the processor and based on the biometric information, a state of intoxication for the individual;
unlocking, by the processor, the gaming device when the state of intoxication for the individual is determined to be less than a predetermined intoxication limit; and
locking, by the processor, the gaming device when the state of intoxication for the individual is determined to be at or above the predetermined intoxication limit.

12. The method of claim 9, wherein prior to interacting with the gaming device, the method further comprises:
scanning, by a biometric feature scanner of a device other than the gaming device, the individual for pregame biometric information; and
sending, by a processor of the device, the pregame biometric information to the gaming device.

13. The method of claim 9, wherein prior to controlling the state of the gaming device, the method further comprises:
accessing, by the processor and across a gaming communication network, a memory device;
determining, by the processor, whether an impersonal player identification (ID) exists in a memory location on the memory device, wherein the impersonal player ID uniquely identifies the individual without the identity information other than the biometric information for the individual; and
retrieving, by the processor, from the memory location on the memory device when the impersonal player ID exists in the memory location on the memory device, gaming experience information for the individual associated with the impersonal player ID.

14. The method of claim 13, wherein controlling the state of the gaming device further comprises:
determining, by the processor and based on the gaming experience information, an access level for the function of the gaming device; and
controlling, by the processor, the state of the gaming device to operate at the determined access level for the function of the gaming device.

15. The method of claim 14, further comprising:
storing, by the processor, updated information in the gaming experience information stored in the memory location on the memory device for the impersonal player ID as a gaming history for the individual changes over time.

16. The method of claim 15, further comprising:
obtaining, periodically by the processor and via the biometric feature scanning device, subsequent biometric information for individuals within the scanning zone of the biometric feature scanning device; and
determining, by the processor comparing the subsequent biometric information obtained to stored biometric information for the individual associated with the impersonal player ID, whether the individual is present at the gaming device.

17. The method of claim 16, wherein the gaming device is connected to a plurality of gaming devices in a gaming facility via the gaming communication network, further comprising:
locking, by the processor, the function of the gaming device when the biometric feature scanning device fails to detect the individual as present at the gaming device; and
unlocking, by the processor, the function of the gaming device when the biometric feature scanning device detects the individual as present at the gaming device.

18. The method of claim 17, further comprising:
determining, by the processor and based on the gaming experience information, that the individual has exceeded a gaming threshold stored in the memory location for the impersonal player ID; and
rendering, by a screen of the gaming device, a message informing the individual that the gaming threshold has been exceeded.

19. A gaming device, comprising:
a biometric scanner;
a processor coupled to the biometric scanner; and
a memory coupled with and readable by the processor and storing therein instructions that, when executed by the processor, cause the processor to:
scan, via the biometric scanner, biometric features of a person within a scanning zone of the biometric scanner;
receive, based on the scan, biometric information defining a relationship between the biometric features of the person scanned;
determine that the biometric information of the person scanned is stored in a memory device comprising memory locations for a plurality of previously scanned people;
retrieve, from a memory location of the memory device and based on the biometric information, a unique impersonal player identification (ID) and gaming information for the person, wherein the memory device is free of identity information for the person other than the biometric information;
determine, based on the gaming information retrieved, whether the person is authorized to access a function of the gaming device; and
operate the gaming device in a locked state preventing access to the function of the gaming device when the person is determined to be unauthorized.

20. The gaming device of claim 19, wherein the instructions further cause the processor to:
operate the gaming device in an unlocked state providing access to the function of the gaming device when the person is determined to be authorized;
determine, from the gaming information retrieved, a gaming experience for the person comprising a playing history for the person over time;
determine, based on the gaming experience, a first level of operation for the gaming device;
operate the gaming device at the first level of operation, wherein the first level of operation for the gaming device provides a first interaction and visual presentation to the person via a screen of the gaming device;
determine, based on a playing event associated with a user interacting with the gaming device, an updated gaming experience for the person;
store the updated gaming experience for the person in the gaming information in the memory location associated with the impersonal player ID for the person on the memory device; and
operate the gaming device at a second level of operation, wherein the second level of operation for the gaming device provides a second interaction and visual presentation to the person via the screen of the gaming device, wherein the second interaction and visual presentation includes unlocked features of the gaming device unavailable in the first interaction and visual presentation, and wherein the memory device does not link to the identity information for the person and does not include any identity information for the person other than the biometric information.
